(19) United States
(12) Patent Application Publication
(10) Pub. No.: US 2022/0101720 A1
(43) Pub. Date: Mar. 31, 2022

(54) TRAFFIC STATUS DISPLAY SYSTEM AND RELATED DISPLAY METHOD

(71) Applicant: Wistron Corporation, New Taipei City (TW)

(72) Inventors: Chia-Hsien Huang, New Taipei City (TW); Cheng-Wei Lin, New Taipei City (TW)

(21) Appl. No.: 17/109,163

(22) Filed: Dec. 2, 2020

(30) Foreign Application Priority Data
Sep. 30, 2020 (TW) 109134001

(51) Int. Cl. G08G 1/01; G06T 11/20; G06F 16/29

(52) U.S. Cl. CPC G08G 1/0125; G06F 16/29; G08G 1/0141; G06T 11/203

(57) ABSTRACT

A traffic status display system for displaying a traffic status display picture is disclosed. The traffic status display picture includes a map information including a plurality of intersection traffic statuses, wherein each intersection traffic status of the plurality of intersection traffic statuses includes a traffic light status display picture configured to display a traffic light status of each sub-intersection of an intersection; and a traffic turning vector display picture, configured to display a flow-out table and a flow-in table of the intersection according to a vehicle traffic data.

### BACKGROUND OF THE INVENTION

### 1. Field of the Invention

The present invention relates to a traffic status display system and related display method, and more particularly, to a traffic status display system and related display method capable of presenting traffic status.

### 2. Description of the Prior Art

With the increasing volume of vehicles on our roads, traffic management units are required to thoroughly control the traffic status of a whole city by providing, for example, data regarding volumes of vehicles at road intersections, average car speed or traffic light status. Vehicle volume and complexity of traffic in big cities will increase along with the development of the city, however; a conventional traffic status display system can only provide real-time traffic status but cannot provide thorough traffic status information for data statistics or analysis of traffic status. Therefore, improvements are necessary to the conventional technique.

### SUMMARY OF THE INVENTION

The present invention provides a traffic status display system and related display method which can thoroughly provide real-time traffic status and related data information.

An embodiment of the present invention discloses a traffic status display system for displaying a traffic status display picture, wherein the traffic status display picture comprises: a map information, including a plurality of intersection traffic statuses, wherein each intersection traffic status of the plurality of intersection traffic statuses comprises: a traffic light status display picture, configured to display a traffic light status of each sub-intersection of an intersection; and a traffic turning vector display picture, configured to display a flow-out table and a flow-in table of the intersection according to a vehicle traffic data.

Another embodiment of the present invention discloses a traffic status display method for a traffic status display system, wherein the traffic status display method comprises: displaying a plurality of intersection traffic statuses; displaying a traffic light status of each sub-intersection of an intersection of a traffic light status display picture; and displaying a flow-out table and a flow-in table of the intersection using a traffic turning vector display picture, according to a vehicle traffic data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a traffic status display picture according to an embodiment of the present invention.

FIG. 2 is a schematic diagram of a traffic light status display picture and a car storage information of an intersection traffic status according to an embodiment of the present invention.

FIG. 3 is a schematic diagram of numbering sub-intersections according to an embodiment of the present invention.

FIG. 4 is a schematic diagram of a traffic turning vector display picture of the intersection traffic status according to an embodiment of the present invention.

FIG. 5 is a schematic diagram of a traffic status display method according to an embodiment of the present invention.

### DETAILED DESCRIPTION

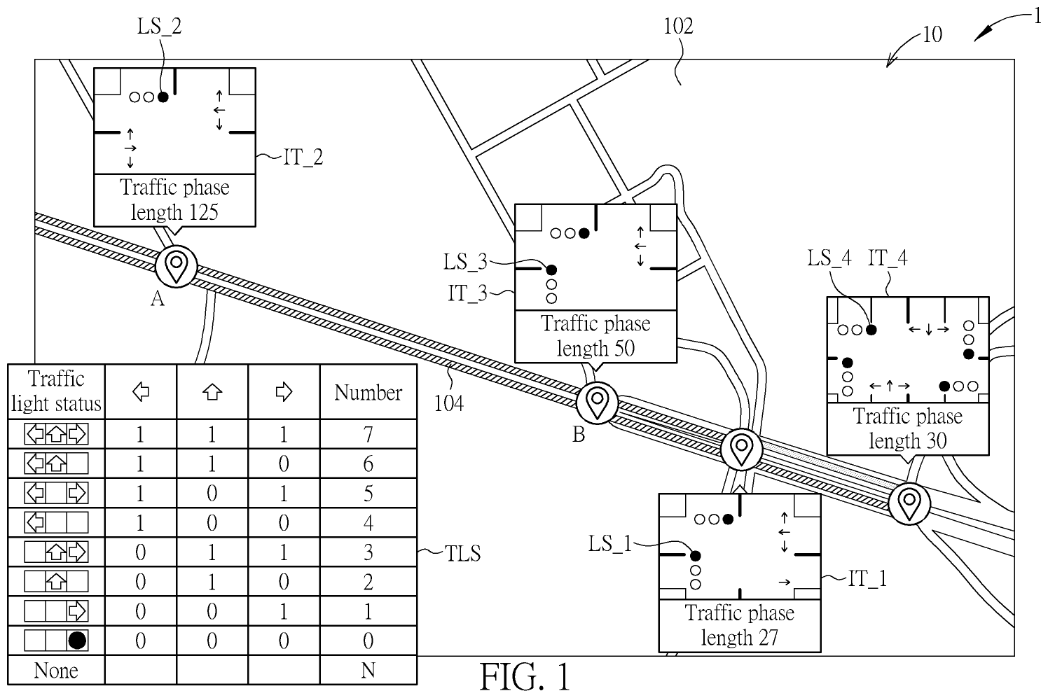

Refer to FIG. 1, which is a schematic diagram of a traffic status display picture 10 according to an embodiment of the present invention. The traffic status display picture 10 is displayed by a traffic status display system 1, wherein the traffic status display picture 10 includes a map information 102 and a car speed information 104. The traffic status display system 1 may be a display, a memory and a central processing unit (CPU), or an electronic device with computing ability to execute corresponding computations and determine the traffic status display picture 10, such that the traffic status display picture 10 is presented on the display. The traffic status display picture 10 may be a user interface for a user that can display different traffic statuses. In an embodiment, the traffic status display picture 10 may be displayed on a webpage, such that the user may browse the traffic status display picture 10 by visiting the webpage. The map information 102 includes a plurality of intersection traffic statuses IT_1-IT_4: for example, the map information 102 may be map information including road names, latitude and longitude co-ordinates of a city, wherein each of the intersection traffic statuses IT_1-IT_4 includes traffic light status display pictures LS_1-LS_4. The map information 102 of the traffic status display picture 10 may present the intersection traffic status IT_1-IT_4 of each of the intersections: for example, the intersection traffic status IT_1 may be a crossroad, wherein roads of the crossroad are all two-way roads, i.e. each sub-intersection may be a one-way road or a two-way road.

As shown in FIG. 1, the traffic light status display picture LS (including the traffic light status display pictures LS_1-LS_4) may be utilized for displaying a traffic light status of each sub-intersection of one intersection, to indicate vehicles at the intersections. The traffic light status display picture LS includes a real-time traffic phase for determining a driving direction for vehicles at the intersections, and the real-time traffic phase of each of the intersections are determined from a default traffic phase, wherein the default traffic phase is obtained from a database (not illustrated in the figures). In addition, the traffic status display system 1 may receive real-time status via a transceiver circuit or a communication circuit, and display the traffic light status display picture LS. For example, by receiving the traffic light status via the transceiver circuit or the communication circuit, the traffic status display system 1 may determine the corresponding traffic light status according to a traffic light status table TLS, such that the traffic light status may be displayed in the traffic light status display picture LS.

The traffic light status table TLS numbers different combinations of left turn, straight, and right turn indications. More specifically, number N represents no traffic light, number 0 displays a red traffic light (representing ‘stop’), number 1 displays a right-turn traffic light, number 2 displays a straight traffic light, number 3 displays straight and right-turn traffic lights, and so on. As such, after the traffic status display system 1 receives the traffic light numbers of the traffic light status display pictures LS_1-LS_4 of each of the intersections, the corresponding traffic light status may be obtained from the traffic light status table TLS, and the traffic status display picture 10 is updated.

The car speed information 104 is utilized for displaying a car speed picture between each of the sub-intersections according to each of the intersection traffic statuses. In an embodiment, the car speed picture may represent smooth traffic or heavy traffic by different colors or different types of lines, e.g. on a city road, slashes represent a car speed lower than 30 km/h, and meshed lines represent the car speed higher than 30 km/h, enabling the car speed status between each of the intersections to be displayed. Notably, the map information 102, the traffic light status display picture LS or the car speed information 104 above may be received by the traffic status display system 1 from the Internet or the communication circuit, and then updated on the traffic status display picture 10.

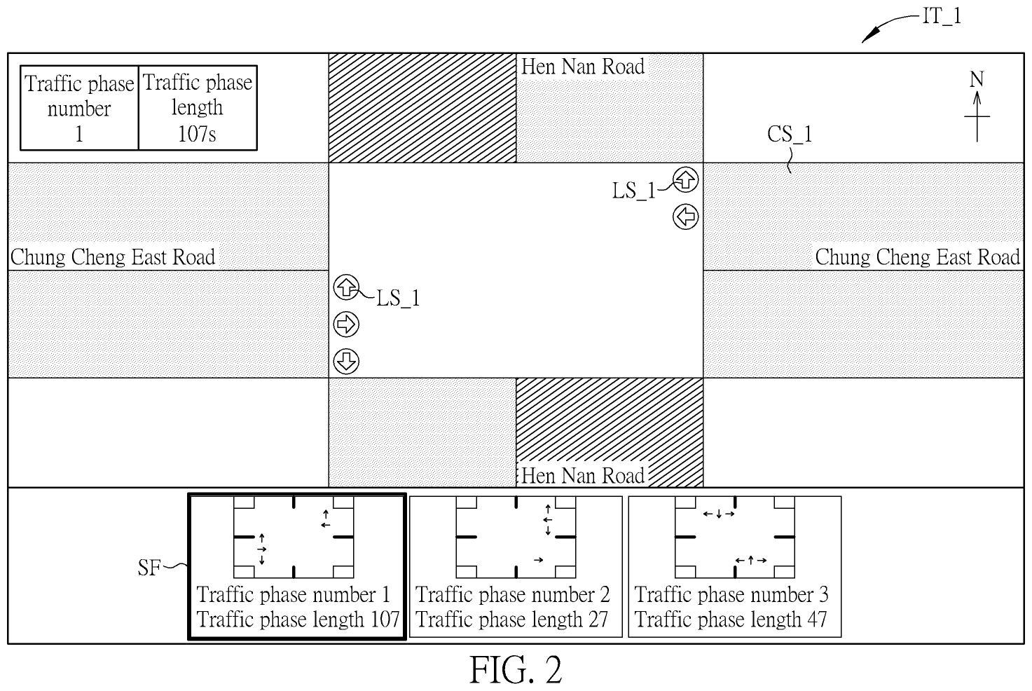

In FIG. 1, the traffic light status display picture LS_1 of the intersection traffic status IT_1 may represent a real-time traffic phase of the intersection, such as a traffic phase number, a length of traffic phase, the car speed picture, a road name and the traffic light status. Refer to FIG. 2, which is a schematic diagram of the traffic light status display picture LS_1 and a car storage information CS_1 of the intersection traffic status IT_1 according to an embodiment of the present invention. In the traffic light status display picture LS_1, the displayed traffic phase number is 1, the traffic phase length is 107 seconds, the east-west road of the intersection is Chung-Cheng East road, and the north-south road of the intersection is Heng-Nan road. The car storage information CS_1 is utilized for determining and displaying a car storage or a car storage status of each intersection according to each of the intersection traffic statuses, wherein the car storage or the car storage status may be obtained from pictures of surveillance cameras of the intersections. For example, different colors or different types of lines may indicate that the car storage is in an adequate or an inadequate condition, e.g. meshed lines represent adequate car storage and slashed lines represent inadequate car storage, enabling the car storage information between each of the intersections to be displayed. In addition, in FIG. 2, a current traffic phase may be highlighted by a square frame SF in the intersection traffic status IT_1, and different light status combinations corresponding to the time phases (i.e. the default traffic phases) may be displayed at the bottom of the intersection traffic status IT_1, wherein the default traffic phases is stored in the database. In practice, a user may click the intersection traffic status IT_1 in FIG. 1 to enlarge the traffic light status display picture LS_1 in FIG. 2, or the traffic status display system 1 may display detailed traffic light statuses in the intersection traffic status IT_1-IT_4 shown in FIG. 1. The invention is not limited to the above embodiments.

The types of each of the intersections are different (e.g. a different amount of road junctions or the direction of the junctions may be different). In order to identify the sub-intersections of intersections, the traffic status display picture 10 of the present invention defines the sub-intersection as having different types. In an embodiment, each of the sub-intersections of the intersection is allocated to four cardinal directions (i.e. up, down, left and right) with an increasing number. When one of the four cardinal directions has multiple sub-intersections, remainders of the increasing numbers corresponding to the cardinal direction are identical when divided by 4.

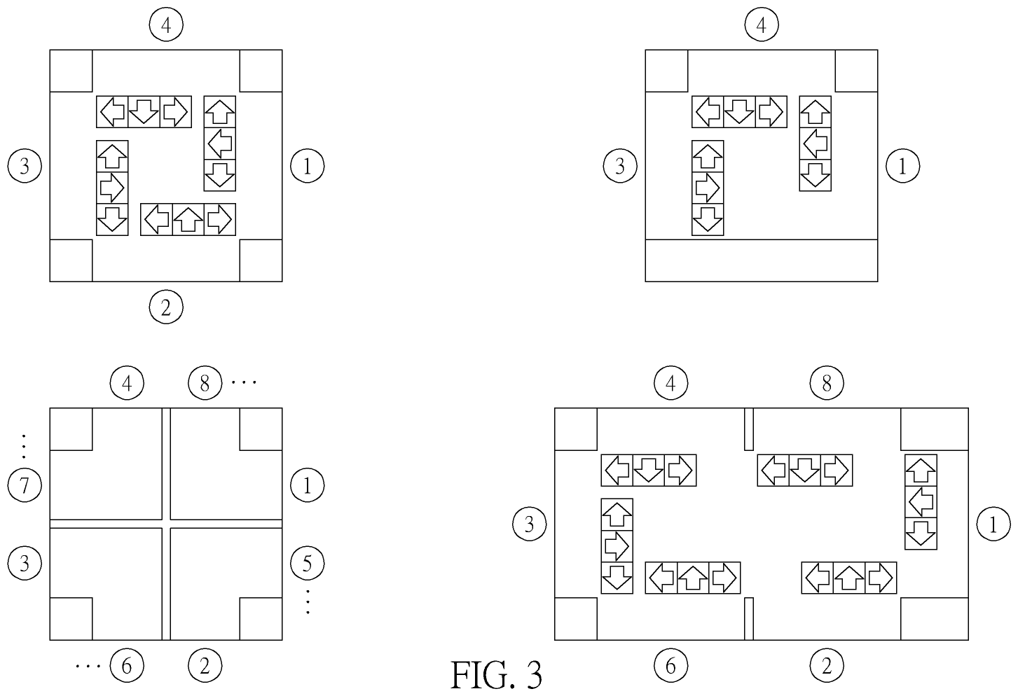

Refer to FIG. 3, which is a schematic diagram of numbering a sub-intersection according to an embodiment of the present invention. In an upper left corner of FIG. 3, four sub-intersections of a crossroad are formed by Chung-Cheng East road (east to west) and Heng-Nan road (north to south). The four sub-intersections are respectively assigned with increasing numbers 1-4 from a starting point, which is the right cardinal direction; in the lower left corner of FIG. 3, the sub-intersections of the intersection are respectively assigned with increasing numbers 1-8; in the upper right corner of FIG. 3, three sub-intersections of a T-shape intersection are respectively assigned with increasing numbers 1, 3, 4; in the lower right corner of FIG. 3, the sub-intersections of the intersection are respectively assigned with increasing numbers 1, 2, 3, 4, 6, 8. As can be known from the above embodiments, the remainders of the increasing numbers at the upper side of the sub-intersection divided by 4 are 0, the remainders of the increasing numbers at the right side of the sub-intersection divided by 4 are 1, the remainders of the increasing numbers at the lower side of the sub-intersection divided by 4 are 2, and the remainders of the increasing numbers at the left side of the sub-intersection divided by 4 are 3, and a sequence of the sub-intersections are displayed clockwise based on the obtained quotient and remainder. When multiple sub-intersections exist atone of the cardinal directions, the remainders of the increasing number of the sub-intersections at the same cardinal direction are identical when divided by 4. Therefore, when an amount of the sub-intersections of the intersection of the traffic status display picture 10 increase, an embodiment of the present invention may number the sub-intersections with different amounts or shapes for calculating traffic volume or illustrating the intersection traffic status IT_1-IT_4.

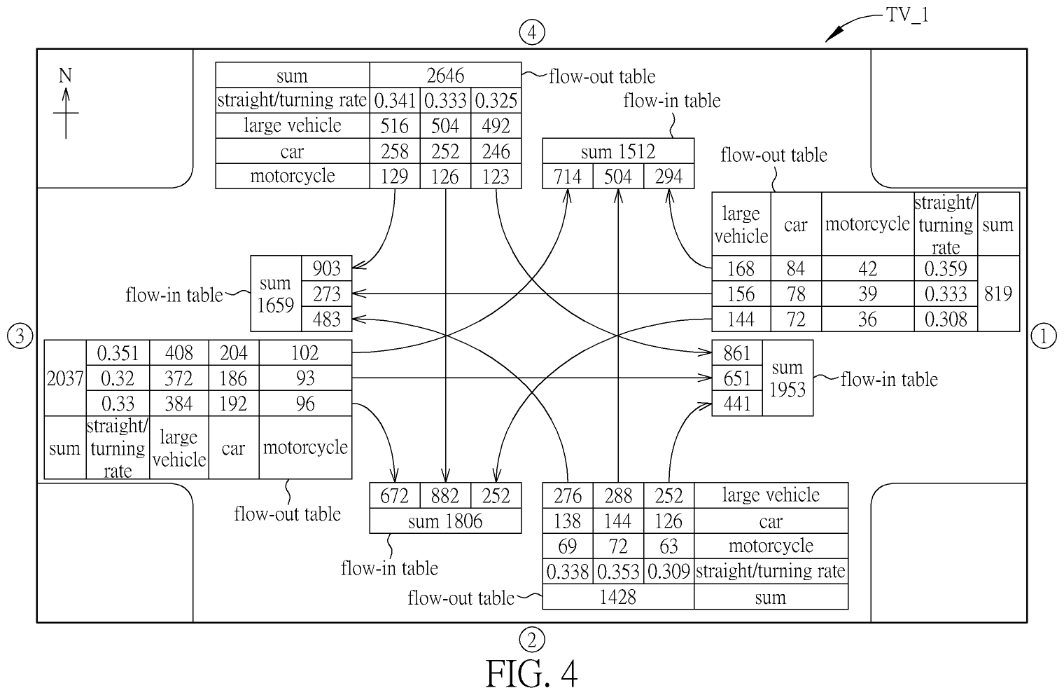

The intersection traffic status IT_1-IT_4 may further include a traffic turning vector display picture TV. Take the intersection traffic status IT_1 as an example. Refer to FIG. 4, which is a schematic diagram of a traffic turning vector display picture TV_1 of the intersection traffic status IT_1 according to an embodiment of the present invention. When the user clicks the intersection traffic status IT_1 in FIG. 1, the traffic status display picture 10 may be switched to display the traffic turning vector display picture TV_1, or the traffic turning vector display picture TV_1 is displayed with a thumbnail in the traffic status display picture 10. The traffic turning vector display picture TV_1 is utilized for displaying a flow-out table and a flow-in table of each of the sub-intersections of the intersection according to a vehicle traffic data of the intersection. In an embodiment, the traffic status display system may calculate a flow-out vehicle volume of each of the sub-intersections based on vehicle detection through cameras and surveillance cameras mounted on each of the sub-intersections, and then a flow-in vehicle volume of each of the sub-intersections of the intersection is obtained accordingly. As shown in FIG. 4, the flow-out table and the flow-in table of the increasing numbers 1-4 corresponding to the sub-intersections are displayed. As can be known from the flow-out table of the sub-intersection with the increasing number 1, 168 large cars, 84 cars, and 42 motorcycles drive from the sub-intersection with the increasing number 1 to the sub-intersection with the increasing number 4; 156 large cars, 78 cars, and 39 motorcycles drive from the sub-intersection with the increasing number 1 to the sub-intersection with the increasing number 3; and 144 large cars, 72 cars, and 36 motorcycles drive from the sub-intersection with the increasing number 1 to the sub-intersection with the increasing number 2. Therefore, 819 vehicles drive out from the sub-intersection with the increasing number 1, and 1953 vehicles drive into the sub-intersection with the increasing number 1 respectively from the increasing numbers 4, 3, 2. In addition, a corresponding straight rate and turning rate are listed in the flow-out table and the flow-in table. Similarly, the traffic turning vector display picture of the intersection traffic status is formed according to the flow-out tables and the flow-in tables of the sub-intersections with increasing numbers 2˜4 and the flow-out table and the flow-in table of the sub-intersections with increasing number 1. Notably, vehicle classifications are not limited to large vehicles, cars and motorcycles; other kinds of traffic vehicles such as bicycles, trucks, and trailer trucks are also applicable to the present invention.

Notably, when the traffic status display system 1 according to an embodiment of the present invention illustrates the traffic turning vector display picture, the flow-out table and the flow-in table of the sub-intersection with the increasing number 1 is horizontal, and the flow-out table and the flow-in table of the sub-intersection with the increasing number 2 is vertical. Display directions of the flow-in table and the flow-out table of the sub-intersections corresponding to different increasing numbers (i.e. the sub-intersections with different remainders when the corresponding increasing number is divided by 4) are different. In an example, as shown in the traffic turning vector display picture TV_1 in FIG. 4, after the traffic status display system 1 calculates the flow-out table and the flow-in table, the traffic status display system 1 is configured to determine whether or not to rotate the flow-out table and the flow-in table according to the remainders of the increasing numbers 1-4 divided by 4, i.e. when the remainders of the increasing numbers divided by 4 are 1 and 3, the flow-out table and the flow-in table are horizontal; when the remainders of the increasing numbers divided by 4 are 2 and 0, the flow-out table and the flow-in table are vertical, i.e. rotated 90 degrees compared to the horizontal flow-out table and flow-in table. As such, the flow-out tables and the flow-in tables in FIG. 4 are displayed and links between each of the sub-intersections are illustrated with curved arrows to represent flow-in or flow-out directions of vehicles.

In order to reduce computation of illustrating traffic status pictures, a 90 degrees, 180 degrees and −90 degrees angle difference respectively exist between the sub-intersections of the increasing number 1 and the sub-intersections with the increasing numbers 2 4 of the traffic light status, as shown in the upper left corner of FIG. 3. After the traffic status display system 1 according to an embodiment of the present invention obtains the traffic phase number of intersections and the default traffic phase information from the database, the sub-intersections with increasing numbers corresponding to the traffic phase number is obtained. As such, the angle differences of the above traffic light statuses are known to illustrate the traffic light status of corresponding sub-intersections, which is shown in the traffic status display picture 10 based on the traffic light status of a single sub-intersection with the increasing number, and the traffic light status corresponding to the sub-intersection is displayed at the corresponding intersection. In an embodiment, after the traffic status display system 1 obtains the increasing numbers corresponding to the sub-intersections, the angle differences are obtained based on the remainders by dividing the increasing number with 4, e.g. when the remainder is 2, the angle difference is 90 degrees; when the remainder is 3, the angle difference is 180 degrees; and when the remainder is 0, the angle difference is −90 degrees, and these figures are utilized for illustrating the traffic light status of the sub-intersections accordingly.

In addition, when illustrating the car speed information of the traffic status display picture 10 in FIG. 1, the car speed information of the two-way road should be presented to display the car speed picture on each road. In order to avoid an overlapping of car speed information on the two-way road, the car speed picture between each of the sub-intersections of the intersection of the traffic status display picture 10 according to an embodiment of the present invention is illustrated based on a link vector and a rotation matrix.

In detail, taking a location A of the intersection traffic status IT 2 and a location B of the intersection traffic status IT 3 as an example, assume that co-ordinates of the locations A and B are (x1, y1) and (x2, y2) corresponding to a central location of the road. The traffic status display system 1 according to an embodiment of the present invention determines the link vector AB=(x2−x1, y2−y1) based on the location A and the location B, and normalizes the vector AB as 1, such that the car speed picture after offset is illustrated based on the rotation matrix. For example, a rotation matrix

$$M = ( \begin{matrix}cos θ & sin θ \\ - s in θ & cos θ\end{matrix} ) \text{:}$$

when an applied traffic scene is left-hand traffic, θ of the rotation matrix M is −90 degrees and the car speed picture is counterclockwise offset; when an applied traffic scene is right-hand traffic, θ of the rotation matrix M is 90 degrees and the car speed picture is clockwise offset. An offset vector may be calculated based on the rotation matrix and a normalized vector to illustrate the offset car speed picture. Practically, since a route between the locations A and B may be a curved road, when the above method is applied on the traffic status display picture 10 of FIG. 1, an open source routing machine (OSRM) or related application interfaces may be utilized for capturing each of the co-ordinates between the locations A and B (i.e. between two intersections) to calculate an offset value of the car speed picture when illustrating the two-way road. Thus, the traffic status display system 1 according to an embodiment of the present invention illustrates the car speed picture of the two-way road by recording the central co-ordinates of the intersections, so as to reduce a setup time cost of the intersection information and storage space of the database.

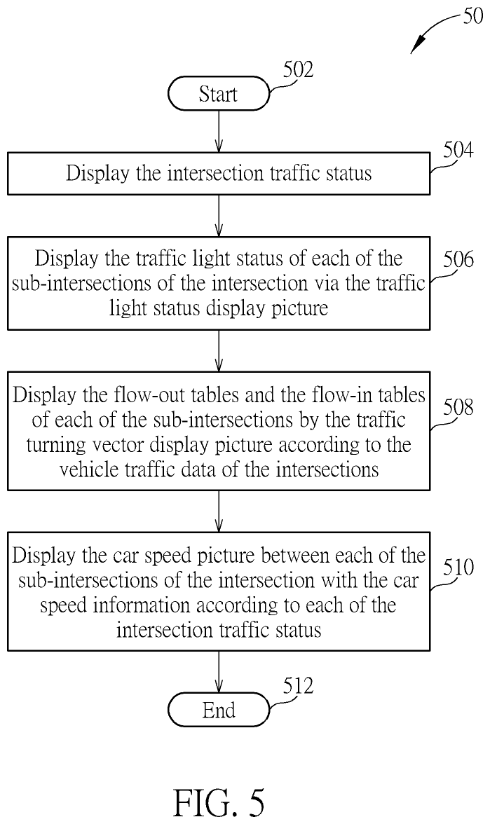

An operation method of the traffic status display picture 10 may be summarized as a traffic status display method 50, as shown in FIG. 5. The traffic status display method 50 includes the following steps:

Step 502: Start.

Step 504: Display the intersection traffic status.

Step 506: Display the traffic light status of each of the sub-intersections of the intersection via the traffic light status display picture.

Step 508: Display the flow-out tables and the flow-in tables of each of the sub-intersections by the traffic turning vector display picture according to the vehicle traffic data of the intersections.

Step 510: Display the car speed picture between each of the sub-intersections of the intersection with the car speed information according to each of the intersection traffic status.

Step 512: End.

Further details about the operation method of the traffic status display method 50 are provided by the embodiments of the traffic status display picture 10 above, and therefore not narrated here for brevity.

Notably, the embodiments of the present invention illustrated above may be properly modified by those skilled in the art, and not limited thereto. For example, the rotation matrix for illustrating the two-way road of the car speed picture, the method of displaying the car storage, the numbering method of the sub-intersections, the display direction of the flow-in tables and the flow-in tables are not limited to the above embodiments, and may be modified according to settings of a user or computer systems, which are applicable to the present invention.

In summary, the traffic status display system and related display method according to an embodiment of the present invention reduces a setup time cost of an intersection information and storage space of the database to thoroughly display the traffic status and related data information of the traffic status.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A traffic status display system, for displaying a traffic status display picture, wherein the traffic status display picture comprises:
a map information, including a plurality of intersection traffic statuses, wherein each intersection traffic status of the plurality of intersection traffic statuses comprises:
a traffic light status display picture, configured to display a traffic light status of each sub-intersection of an intersection; and
a traffic turning vector display picture, configured to display a flow-out table and a flow-in table of the intersection according to a vehicle traffic data.

2. The traffic status display system of claim 1, wherein the traffic light status display picture of each intersection traffic status of the plurality of intersection traffic statuses is determined according to a corresponding real-time traffic phase and a corresponding default traffic phase, and the default traffic phase is obtained from a database, wherein the traffic light status display picture includes different combinations of traffic phases of each sub-intersection.

3. The traffic status display system of claim 1, wherein each sub-intersection has an increasing number, when a cardinal direction of four cardinal directions has a plurality of sub-intersections, remainders of the increasing numbers corresponding to the plurality of sub-intersections of the cardinal direction are identical when divided by 4.

4. The traffic status display system of claim 3, wherein a first display direction of a first flow-out table and a first flow-in table of a first sub-intersection of the intersection of the traffic turning vector display picture are different from a second display direction of a second flow-out table and a second flow-in table of a second sub-intersection of the intersection of the traffic turning vector display picture, wherein remainders of the increasing numbers corresponding to the first sub-intersection and the second sub-intersection are different when divided by 4.

5. The traffic status display system of claim 4, wherein the traffic turning vector display picture comprises curve arrows related to the first flow-out table of the first sub-intersection and the second flow-in table of the second sub-intersection.

6. The traffic status display system of claim 3, wherein a rotation angle difference exists between a first traffic light status of a first sub-intersection and a second traffic light status of a second sub-intersection of the traffic light status display picture, wherein the rotation angle difference is related to increasing numbers of the first sub-intersection and the second sub-intersection, wherein remainders of the increasing numbers of the first sub-intersection and the second sub-intersection are different when divided by 4.

7. The traffic status display system of claim 1, wherein each intersection traffic status of the plurality of intersection traffic status further comprises:
a car storage information, configured to determine and display a car storage or a car storage status of each intersection according to each intersection traffic status of the plurality of intersection traffic statuses.

8. The traffic status display system of claim 1, wherein the traffic status display picture comprises:
a car speed information, configured to display a car speed picture between the plurality of intersections according to each intersection traffic status of the plurality of intersection traffic statuses.

9. The traffic status display system of claim 8, wherein the car speed picture between the plurality of intersections is illustrated according to a link vector and a rotation matrix of a first intersection and a second intersection of the plurality of intersections.

10. The traffic status display system of claim 1, wherein the traffic light status display picture is updated by a traffic light status number, the traffic light status display picture referencing a traffic light status table including the traffic light status number.

11. A traffic status display method for a traffic status display system, wherein the traffic status display method comprises:
displaying a plurality of intersection traffic statuses;
displaying a traffic light status of each sub-intersection of an intersection of a traffic light status display picture; and
displaying a flow-out table and a flow-in table of the intersection, by a traffic turning vector display picture, according to a vehicle traffic data.

12. The traffic status display method of claim 11, wherein the traffic light status display picture of each intersection traffic status of the plurality of intersection traffic statuses is determined according to a corresponding real-time traffic phase and a corresponding default traffic phase, and the default traffic phase is obtained from a database, wherein the traffic light status display picture includes different combinations of traffic phases of each sub-intersection.

13. The traffic status display method of claim 11, wherein each sub-intersection has an increasing number, and when a cardinal direction of four cardinal directions has a plurality of sub-intersections, remainders of the increasing numbers corresponding to the plurality of sub-intersections of the cardinal direction are identical when divided by 4.

14. The traffic status display method of claim 13, wherein a first display direction of a first flow-out table and a first flow-in table of a first sub-intersection of the intersection of the traffic turning vector display picture are different from a second display direction of a second flow-out table and a second flow-in table of a second sub-intersection of the intersection of the traffic turning vector display picture, wherein remainders of the increasing numbers of the first sub-intersection and the second sub-intersection are different when divided by 4.

15. The traffic status display method of claim 14, wherein the traffic turning vector display picture comprises curve arrows related to the first flow-out table of the first sub-intersection and the second flow-in table of the second sub-intersection.

16. The traffic status display method of claim 13, wherein a rotation angle difference exists between a first traffic light status of a first sub-intersection and a second traffic light status of a second sub-intersection of the traffic light status display picture, wherein the rotation angle difference is related to increasing numbers of the first sub-intersection and the second sub-intersection and remainders of the increasing numbers of the first sub-intersection and the second sub-intersection are different when divided by 4.

17. The traffic status display method of claim 11, further comprising:
determining a car storage of each intersection according to each intersection traffic status of the plurality of intersection traffic statuses and displaying the car storage or a car storage status of each intersection by a car storage information.

18. The traffic status display method of claim 11, further comprising:
displaying a car speed picture between the plurality of intersections according to a car speed information of each intersection traffic status of the plurality of intersection traffic statuses.

19. The traffic status display method of claim 18, wherein the car speed picture between the plurality of intersections is illustrated according to a link vector and a rotation matrix of a first intersection and a second intersection of the plurality of intersections.

20. The traffic status display method of claim 11, wherein the traffic light status display picture is updated by a traffic light status number, the traffic light status display picture referencing a traffic light status table including the traffic light status number.
